(19) United States
(12) Patent Application Publication
(10) Pub. No.: US 2026/0119041 A1
(43) Pub. Date: Apr. 30, 2026

(54) DATA ACCESS APPARATUS AND OPERATING METHOD THEREOF

(71) Applicant: Samsung Electronics Co., Ltd., Suwon-si (KR)

(72) Inventors: Wonseb Jeong, Suwon-si (KR); Sangsu Park, Suwon-si (KR); Hyunsub Song, Suwon-si (KR); Chihun Won, Suwon-si (KR); Younggeon Yoo, Suwon-si (KR); Donghun Lee, Suwon-si (KR)

(73) Assignee: Samsung Electronics Co., Ltd., Suwon-si (KR)

(21) Appl. No.: 19/209,501

(22) Filed: May 15, 2025

(30) Foreign Application Priority Data
Oct. 28, 2024 (KR) 10-2024-0148958

(51) Int. Cl. G06F 3/06; G06F 9/48

(52) U.S. Cl. CPC G06F 3/0611; G06F 3/0659; G06F 3/0673; G06F 9/4881

(57) ABSTRACT

Provided is a data access apparatus including a processing unit array configured to perform computation for each of a plurality of data-sets, a data-set access scheduler configured to generate data-set access order information based on information on a plurality of data-set addresses for the plurality of data-sets and long-latency analysis information, a data-set state analyzer configured to generate the long-latency analysis information based on the information on the plurality of data-set addresses and state information, and a data-set manager configured to access data-sets in heterogeneous memories including a first memory and a second memory based on the data-set access order information.

### CROSS-REFERENCE TO RELATED APPLICATION

This application is based on and claims priority under 35 U.S.C. § 119 to Korean Patent Application No. 10-2024-0148958, filed on Oct. 28, 2024, in the Korean Intellectual Property Office, the disclosure of which is incorporated by reference herein in its entirety.

### BACKGROUND

An accelerator capable of high-speed data computation is used for data computation of an artificial intelligence (AI) application, such as a large language model (LLM).

Generally, dynamic random-access memory (DRAM) is used as a memory for an accelerator. However, the capacity of the DRAM is insufficient to store an LLM and the DRAM has problems with the power supply required for an LLM computation.

Therefore, in calculations by the accelerator, it is required to simultaneously implement a large-capacity memory capable of storing both a large-capacity AI model and intermediate data generated during the calculation process, and a high-speed memory capable of reducing the performance degradation of the accelerator due to long latency.

### SUMMARY

The inventive concept provides a data access apparatus capable of reducing latency in data access in the process of computing a large amount of data by using heterogeneous memories, and an operating method thereof.

According to an aspect of the inventive concept, there is provided a data access apparatus including, a data-set access scheduler configured to generate data-set access order information based on information on a plurality of data-set addresses for a plurality of data-sets and long-latency analysis information, a data-set manager configured to access the plurality of data-sets in heterogeneous memories including a first memory and a second memory based on the data-set access order information, and a data-set state analyzer configured to generate the long-latency analysis information based on the information on the plurality of data-set addresses and state information for the second memory.

According to another aspect of the inventive concept, there is provided a data access apparatus including a first memory configured to store at least one of a data-set required for computation of a plurality of data-sets and an intermediate data-set generated during the computation, a second memory configured to store the plurality of data-sets, a data-set access scheduler configured to receive information on a plurality of data-set addresses, generate a request for analysis of long latency in access to one or more data-sets, and generate data-set access order information with reduced long latency based on long-latency analysis information corresponding to the request for analysis of long latency, a data-set state analyzer configured to receive the information on the plurality of data-set addresses, receive the request for analysis of long latency from the data-set access scheduler, receive state information for the second memory, generate the long-latency analysis information for access to the one or more data-sets based on the information on the plurality of data-set addresses, the request for analysis of long latency, and the state information for the second memory, and transmit the long-latency analysis information to the data-set access scheduler, a workload scheduler configured to receive the data-set access order information from the data-set access scheduler and generate data-set computation order information for the plurality of data-sets based on the data-set access order information, and a data-set manager configured to receive the data-set access order information from the data-set-access scheduler, and access the data-sets in heterogeneous memories including the first memory and the second memory based on the data-set access order information, wherein the first memory includes a buffer memory and the second memory includes a non-volatile memory.

According to another aspect of the inventive concept, there is provided an operating method of a data access apparatus including heterogeneous memories including a first memory and a second memory and performing computation operations on each of a plurality of data-sets, wherein the operating method includes analyzing whether long latency occurs in access to the plurality of data-sets based on information on a plurality of data-set addresses for the plurality of data-sets, a request for analysis of long latency, and state information for the second memory, and generating long-latency analysis information, generating data-set access order information for the plurality of data-sets based on the long-latency analysis information, and accessing the first memory and the second memory based on the data-set access order information, wherein the first memory includes a buffer memory and the second memory includes a non-volatile memory.

### BRIEF DESCRIPTION OF THE DRAWINGS

Embodiments will be more clearly understood from the following detailed description taken in conjunction with the accompanying drawings in which:

FIG. 1 is a block diagram of a data access apparatus, according to some embodiments;

FIG. 2 is a block diagram of a second memory and an NVM controller, according to some embodiments;

FIG. 3 is a flowchart of an operating method of a data access apparatus, according to some embodiments;

FIG. 4 is a flowchart of a method of generating data-set access order information with reduced long latency of a second memory, according to some embodiments;

FIG. 5 is a diagram illustrating a case where long latency occurs in data-set access, according to some embodiments;

FIGS. 6 to 9 are diagrams illustrating an operation of generating data-set access order information with reduced long latency based on long-latency analysis information, according to some embodiments;

FIG. 10 is a diagram illustrating a case where long latency occurs in data-set access, according to some embodiments;

FIG. 11 is a diagram illustrating an operation of generating data-set access order information with reduced long latency based on long-latency analysis information, according to some embodiments; and

FIG. 12 is a diagram of a system to which a data access apparatus, according to some embodiments, is applied.

### DETAILED DESCRIPTION OF THE EMBODIMENTS

Hereinafter, various embodiments are described in detail with reference to the accompanying drawings.

The inventive concept relates to a data access apparatus and an operating method thereof, and more particularly, to a data access apparatus that minimizes long latency in data access and an operating method thereof.

Described herein are methods to mitigate the negative effects of latency in a data access apparatus. Latency in a data access apparatus can occur for a variety of reasons, including for example as a result of multiple requests to access the same location of a memory, or due to the activation of a garbage collection routine or defensive code. Latency leads to unwanted delays when accessing data from a memory, which in turn can degrade the performance of a processing array unit as it processes the data. The inventors have recognized that the negative effects of latency can be mitigated by generating information indicating the order in which data-sets are to be accessed from a memory based on an analysis of long-latency information. The long-latency analysis information indicates the level of latency to be expected when accessing a memory. Accessing data-sets from the memory based on the generated order information reduces the impact of latency.

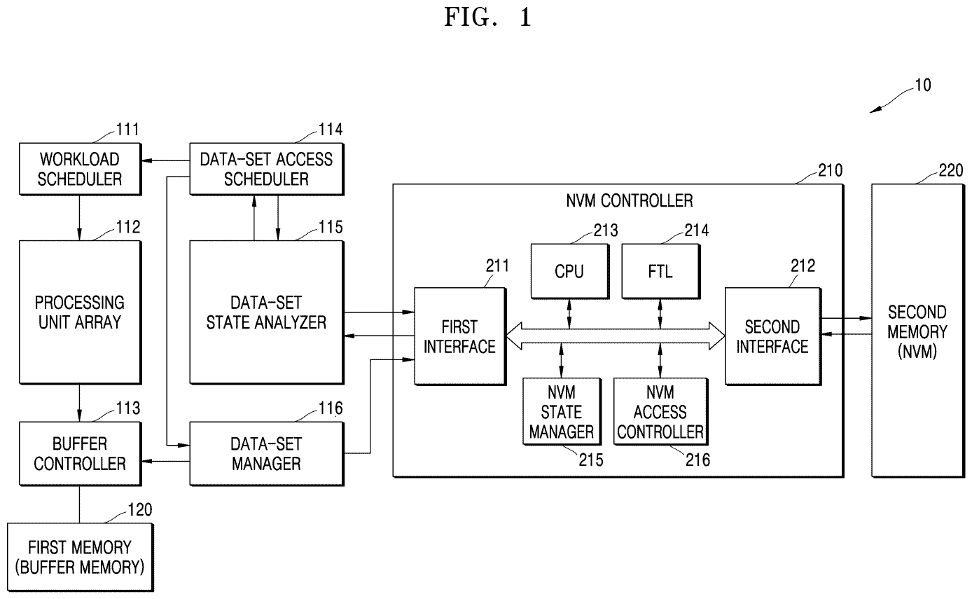

FIG. 1 is a block diagram of a data access apparatus 10, according to some embodiments.

Referring to FIG. 1, the data access apparatus 10 may include a workload scheduler 111, a processing unit array 112, a buffer controller 113, a data-set access scheduler 114, a data-set state analyzer 115, a data-set manager 116, a first memory 120, an NVM controller 210, and a second memory 220. Each of the workload scheduler 111, the data-set access scheduler 114, the data-set state analyzer 115, and the data-set manager 116 may be implemented using hardware, software, or a combination thereof.

In some embodiments, the data access apparatus 10 may include an accelerator, which is a dedicated circuit for high-speed data computation, such as artificial intelligence (AI) data computation. For example, the data access apparatus 10 may include a graphics processing unit (GPU), a neural processing unit (NPU), and/or a data processing unit (DPU).

The first memory 120 may store data resulting from the computation by the processing unit array 112 and may store data to be used for the computation. In addition, the first memory 120 may function as a buffer memory for temporarily storing data to be transmitted to an NVM controller 210 and a second memory 220 or data transmitted from the NVM controller 210 and the second memory 220. Herein, the first memory 120 may include a buffer memory or a buffer memory device. The buffer memory and the buffer memory device may include a volatile memory and a volatile memory device. The volatile memory and the volatile memory device may include DRAM and DRAM device.

When the second memory 220 includes flash memory, the flash memory may include a two-dimensional (2D) memory array or a three-dimensional (3D) (or vertical) NAND (VNAND) memory array. As another example, the second memory 220 may include other various types of non-volatile memories. For example, the second memory 220 may include magnetic random-access memory (MRAM), spin-transfer torque MRAM, conductive bridging RAM (CBRAM), ferroelectric RAM (FeRAM), phase-change RAM (PRAM), resistive RAM (RRAM), and other types of memories. The second memory 220 may include non-volatile memory device.

The workload scheduler 111 may generate data-set computation order information for a plurality of data-sets based on data-set access order information received from the data-set access scheduler 114. The data-set may include a target of a workload computed by a processing unit of the processing unit array 112 and may include a unit of a data that is subject of a specific computation.

The processing unit array 112 may include a plurality of processing units and may perform computation on the plurality of data-sets based on the data-set computation order information received from the workload scheduler 111. The processing unit array 112 may perform computation on a data-set only when access to each of a plurality of data-subsets constituting the data-set is completely completed.

The buffer controller 113 may manage an operation of storing, in the first memory 120, an intermediate data-set generated during the computation of the processing unit array 112, storing, in the second memory 220, the intermediate data-set stored in the first memory 12, or storing, in the first memory 220, the data-set required for the computation of the second memory 220.

Upon receiving information on a plurality of data-set addresses, the data-set access scheduler 114 may schedule an access order for the plurality of data-sets corresponding to the information on the plurality of data-set addresses. The data-set access scheduler 114 according to some embodiments may request the data-set state analyzer 115 to analyze whether long latency occurs in access to one or more data-sets of the plurality of data-sets. Whether the long latency occurs may be determined by whether the access completion time for the one or more data-sets of the plurality of data-sets is later than the access completion time for most data-sets of the plurality of data-sets by a reference time or greater.

The data-set access scheduler 114 may schedule an access order for the plurality of data-sets to reduce long latency upon receiving the analysis result from the data-set state analyzer 115 that the long latency occurs in the access to the one or more data-sets.

The data-set state analyzer 115 may receive the same information as the information on the plurality of data-set addresses received by the data-set access scheduler 114. In addition, the data-set state analyzer 115 may receive, from the data-set access scheduler 114, a request for analysis of long latency in the access to the one or more data-sets. In addition, the data-set state analyzer 115 may receive the non-volatile memory (NVM) state information from the NVM controller 210. The data-set state analyzer 115 may analyze whether long latency occurs in the access to the one or more data-sets based on the information on the plurality of data-set addresses, the request for analysis of long latency, and the NVM state information. For example, when there are many pending access requests to locations where the data-sets are stored, garbage collection is activated or to be activated, or defensive code is activated or to be activated, the data-set state analyzer 115 may generate the analysis result that long latency occurs in access to the location. The access request may include a write request, a read request, or the like.

The data-set manager 116 may receive data-set access order information from the data-set access scheduler 114 and may access the data-sets in the first memory 120 and the second memory 220 based on the data-set access order information.

The NVM controller 210 may include a first interface 211, a second interface 212, and a central processing unit (CPU) 213. In addition, the NVM controller 210 may further include a flash translation layer (FTL) 214, an NVM state manager 215, and an NVM access controller 216. The NVM controller 210 may further include a working memory to which the FTL 214 is loaded. The data write and read operations to the second memory 220 may be controlled by the CPU 213 executing the FTL 214.

The first interface 211 may transmit and receive a packet to and from the data-set state analyzer 115 and the data-set manager 116. The packet transmitted to the first interface 211 may include a command or data to be written to the second memory 220 and the packet transmitted from the first interface 212 may include a response to the command or data read from the second memory 220. The second interface 212 may transmit data to be written into the second memory 220 to the second memory 220 or may receive data read from the second memory 220. The second interface 212 may be implemented to comply with a standard protocol, such as Toggle or Open NAND flash interface (ONFI).

The FTL 214 may perform several functions, such as address mapping, wear-leveling, and garbage collection. The address mapping includes an operation of changing a logical address received from the data-set state analyzer 115 or the data-set manager 116 to a physical address used to actually store data in the second memory 220. The wear-leveling includes a technique for preventing excessive degradation of a specific block by allowing blocks in the second memory 220 to be used uniformly. For example, the wear-leveling may be implemented through firmware for balancing erase counts of physical blocks. The garbage collection includes a technique for securing usable capacity in the second memory 220 by copying valid data of a block to a new block and then erasing the existing block.

The NVM state manager 215 may generate the NVM state information. The NVM state information may include information about whether there are pending access requests, whether garbage collection is activated or to be activated, or whether defensive code is activated or to be activated.

The NVM access controller 216 may control the second interface 212 to transmit data to be written into the second memory 220 to the second memory 220 or to receive data read from the second memory 220.

The data access apparatus 10 according to the inventive concept may include heterogeneous memories, i.e., the first memory 120 and the second memory 220, capable of storing an AI model and intermediate data generated during the computation process. The data access apparatus 10 may store data-sets in the second memory 220 by scheduling the access order for the data-sets distributed and stored in the large-capacity memory to reduce the latency. Therefore, the performance degradation of the data access apparatus 10 due to overhead of movement of the data-sets may be reduced.

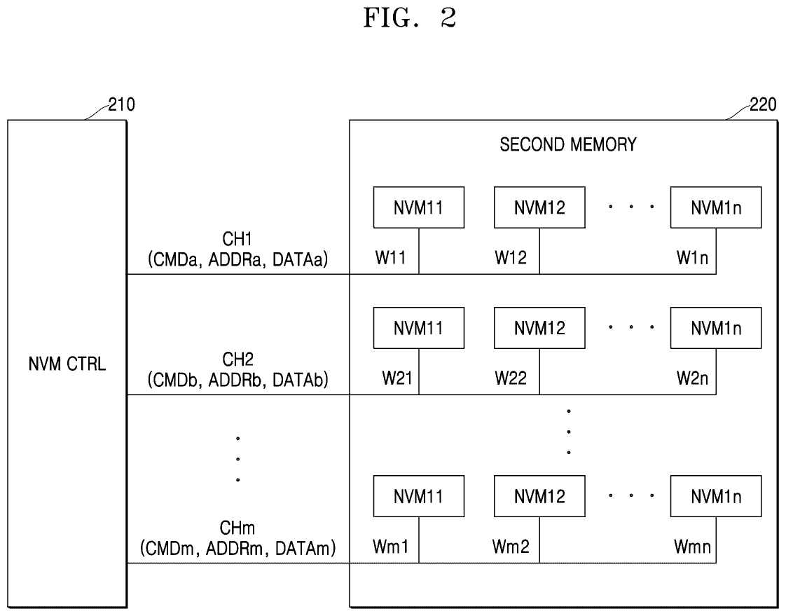

FIG. 2 is a block diagram of a second memory 220 and an NVM controller 210, according to some embodiments.

Referring to FIG. 2, the second memory 220 and the NVM controller 210 may be connected to each other through a plurality of channels CH1 to CHm.

The second memory 220 may include a plurality of NVM devices NVM11 to NVMmn. Herein, the plurality of NVM devices may be referred to as a plurality of NVMs. Each of the plurality of NVM devices NVM11 to NVMmn may be connected to one of the plurality of channels CHI to CHm through a corresponding way. For example, the plurality of NVM devices NVM11 to NVMIn may be connected to a first channel CH1 through ways W11 to Win and the plurality of NVM devices NVM21 to NVM2n may be connected to a second channel CH2 through ways W21 to W2n. In some embodiments, each of the plurality of NVM devices NVM11 to NVMmn may be implemented in arbitrary unit of memory capable of performing an operation according to a respective instruction from the NVM controller 210. For example, each of the plurality of NVM devices NVM11 to NVMmn may be implemented as a chip or a die but the inventive concept is not limited thereto.

The NVM controller 210 may transmit and receive signals to and from the second memory 220 through the plurality of channels CH1 to CHm. For example, the NVM controller 210 may transmit commands CMDa to CMDm, addresses ADDRa to ADDRm, and data DATAa to DATAm to the second memory 220 through the plurality of channels CHI to CHm or may receive the data DATAa to DATAm from the second memory 220.

Through each channel, the NVM controller 210 may select one of the plurality of NVM devices NVM11 to NVMmn connected to the channel and may transmit and receive signals to and from the selected NVM device. For example, the NVM controller 210 may select the NVM device NVM11 from among the plurality of NVM devices NVM11 to NVMIn connected to the first channel CH1. The NVM controller 210 may transmit the command CMDa, the address ADDRa, and the data DATAa to the selected NVM device NVM11 through the first channel CH1 or may receive the data DATAa from the selected NVM device NVM11.

The NVM controller 210 may transmit and receive signals to and from the second memory 220 in parallel through different channels. For example, the NVM controller 210 may transmit the command CMDb to the second memory 220 through the second channel CH2 while transmitting the command CMDa to the second memory 210 through the first channel CH1. For example, the NVM controller 210 may receive the data DATAb from the second memory 220 through the second channel CH2 while receiving the data DATAa from the second memory 210 through the first channel CH1.

The NVM controller 210 may control the overall operation of the second memory 220. The NVM controller 210 may control each of the plurality of NVM devices NVM11 to NVMmn connected to the plurality of channels CH1 to CHm by transmitting signals to the plurality of channels CH1 to CHm. For example, the NVM controller 210 may control the selected one of the plurality of NVM devices NVM11 to NVMIn by transmitting the command CMDa and the address ADDRa to the first channel CH1.

Each of the plurality of NVM devices NVM11 to NVMmn may operate under the control by the NVM controller 210. For example, the NVM device NVM11 may program the data DATAa according to the command CMDa and the address ADDRa provided to the first channel CH1. For example, the NVM device NVM21 may read the data DATAb according to the command CMDb and the address ADDRb provided to the second channel CH2 and may transmit the read data DATAb to the NVM controller 210.

It is shown in FIG. 2 that the second memory 220 is in communication with the NVM controller 210 through m channels and the second memory 220 includes n NVM devices corresponding to each channel. However, the number of channels and the number of NVM devices connected to one channel may vary.

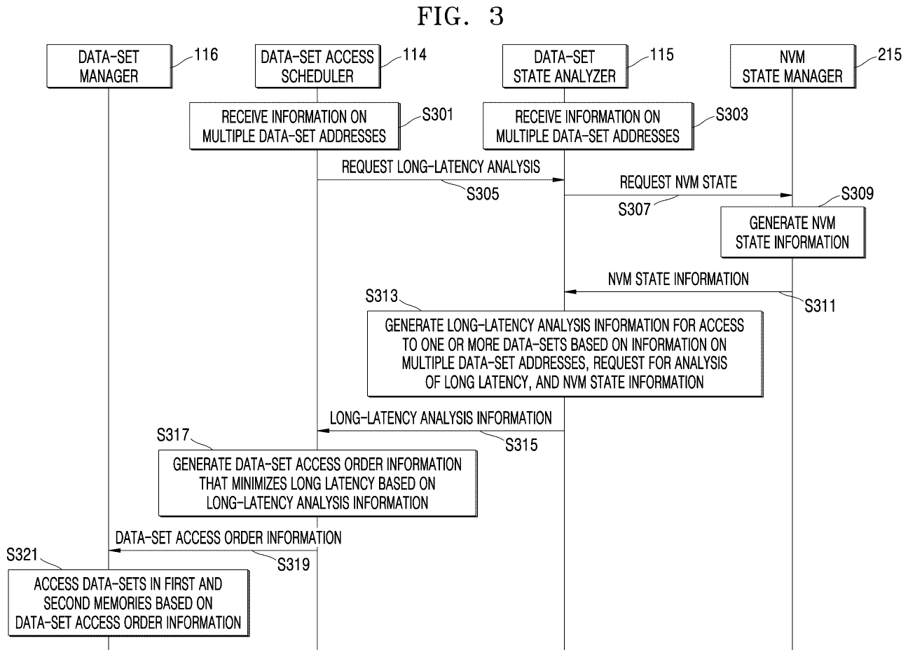

FIG. 3 is a flowchart of an operating method of a data access apparatus, according to some embodiments.

Referring to FIG. 3, the data-set access scheduler 114 and the data-set state analyzer 115 each receive information on a plurality of data-set addresses (S301 and S303). The information on the plurality of data-set addresses may include information indicating locations where a plurality of data-subsets constituting each of the plurality of data-sets are stored in the second memory 220.

The data-set access scheduler 114 generates a request for analysis of long latency in access to one or more data-sets and transmits the request for analysis of long latency to the data-set state analyzer 115 (S305). The one or more data-sets may include at least some of the plurality of data-sets corresponding to the information on the plurality of data-set addresses.

The data-set state analyzer 115 transmits an NVM state request to the NVM state manager 215 (S307). For example, the data-set state analyzer 115 may generate the NVM state request when receiving the information on the plurality of data-set addresses or when receiving the request for analysis of long latency.

The NVM state manager 215 generates NVM state information in response to the NVM state request (S309) and transmits the generated NVM state information to the data-set state analyzer 115 (S311). The NVM state information may include information indicating, for example, the number of pending access requests to a plurality of locations where the plurality of data-subsets constituting one or more data-sets are stored, whether garbage collection is activated, whether defensive code is activated, or the like.

The data-set state analyzer 115 generates long-latency analysis information for access to one or more data-sets based on the information on the plurality of data-set addresses, the request for analysis of long latency, and the NVM state information (S313), and transmits the long-latency analysis information to the data-set access scheduler 114 (S315).

The data-set state analyzer 115 may identify one or more data-sets from the request for analysis of long latency, may extract addresses of the one or more data sets from the information on the plurality of data-set addresses, and may extract, from the NVM state information, NVM states of the locations where the one or more data-sets are stored. The data-set state analyzer 115 may analyze whether long latency occurs in access to one or more data-sets based on the identification result and the extraction result. For example, the data-set state analyzer 115 may generate the analysis result that long latency occurs in access to one or more data-sets due to more than the predetermined number of pending access requests to at least one of the plurality of locations where the plurality of data-subsets constituting the one or more data sets are stored, the garbage collection being activated, or the defensive code being activated.

The data-set access scheduler 114 generates data-set access order information with reduced long latency based on the long-latency analysis information (S317) and transmits the data-set access order information to the data-set manager 116 (S319).

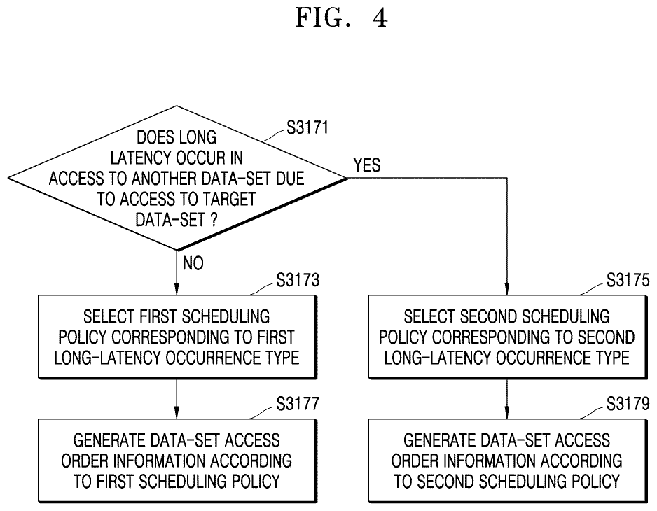

When long latency occurs in access to the one or more data-sets, the data-set access scheduler 114 may generate the data-set access order information by, for example, changing an access order for the one or more data-sets of the plurality of data-sets or changing an access order for the other data-sets of the plurality of data-sets. In the following, operation S317 in FIG. 3 may be described in more detail with reference to FIGS. 4 to 11.

The data-set manager 116 accesses the data-sets in heterogeneous memories including the first memory and the second memory based on the data-set access order information (S321).

The first memory according to some embodiments may include the first memory 120 in FIG. 1 and the second memory according to some embodiments may include the second memory 220 in FIG. 1. For example, the first memory may include dynamic random-access memory (DRAM) and the second memory may include NAND flash memory. The first memory may be provided as a memory suitable for fast computation of the processing unit array 112 in FIG. 1 and the second memory may be provided as a memory suitable for large-scale computation, such as a large language model (LLM) of the processing unit array 112 in FIG. 1.

FIG. 4 is a flowchart of a method of generating data-set access order information with reduced long latency of a second memory 220, according to some embodiments.

Referring to FIG. 4, the data-set access scheduler 114 determines whether long latency occurs in access to another data-set due to access to a target data-set based on the long-latency analysis information (S3171).

When long latency does not occur in the access to another data-set due to the access to the target data-set (S3171, NO), the data-set access scheduler 114 determines a type in which the long latency occurs as a first long-latency occurrence type and selects a first scheduling policy that reduces the long latency of the first long-latency occurrence type (S3173).

The first long-latency occurrence type may include a type in which long latency occurs in the access to the target data-set. For example, when there are a large number of pending access requests to locations where first data-subsets constituting a first data-set is stored, the garbage collection is activated or to be activated, or the defensive code is active or to be activated, the data-set access scheduler 114 may distinguish a type in which the long latency occurs as the first long-latency occurrence type.

The first scheduling policy that reduces the long latency of the first long-latency occurrence type may include, for example, a policy that changes the access to the first data-subsets to the highest priority at the location where the first data-subsets are stored, a policy that induces early activation of the scheduled garbage collection or defensive code, or the like.

Referring to FIG. 4, when long latency occurs in access to another data-set due to the access to the target data-set (S3171, YES), the data-set access scheduler 114 distinguishes a type in which the long latency occurs as a second long-latency occurrence type and selects a second scheduling policy that reduces the long latency of the second long-latency occurrence type (S3175).

The second long-latency occurrence type may include a type in which long latency occurs in access to another data-set due to the access to the target data-set. For example, when both the first data-subsets constituting the first data-set and the second data-subsets constituting the second data-set are stored in the first location, the number of access requests to the first location may be greater than or equal to a predetermined number due to the access to the first data-subsets, thereby limiting the access to the second data-subsets, or the garbage collection or the defensive code may be activated in the first location due to the access to the first data-subsets, thereby limiting the access to the second data-subsets. In this case, the data-set access scheduler 114 may distinguish the type in which the long latency occurs as the second long-latency occurrence type.

The second scheduling policy that reduces the long latency of the second long-latency occurrence type may include a policy that changes the access order such that the access to the second data-subsets is prior to the access to the first data-subsets in the first location, a policy that changes the access order such that the access to the first data-subsets is prior to the access to the second data-subsets in the first location, or a policy that changes the access order such that the garbage collection or the defensive code to be activated is activated early in the first location.

The data-set access scheduler 114 generates data-set access order information according to the first scheduling policy (S3177) or generates data-set access order information according to the second scheduling policy (S3179).

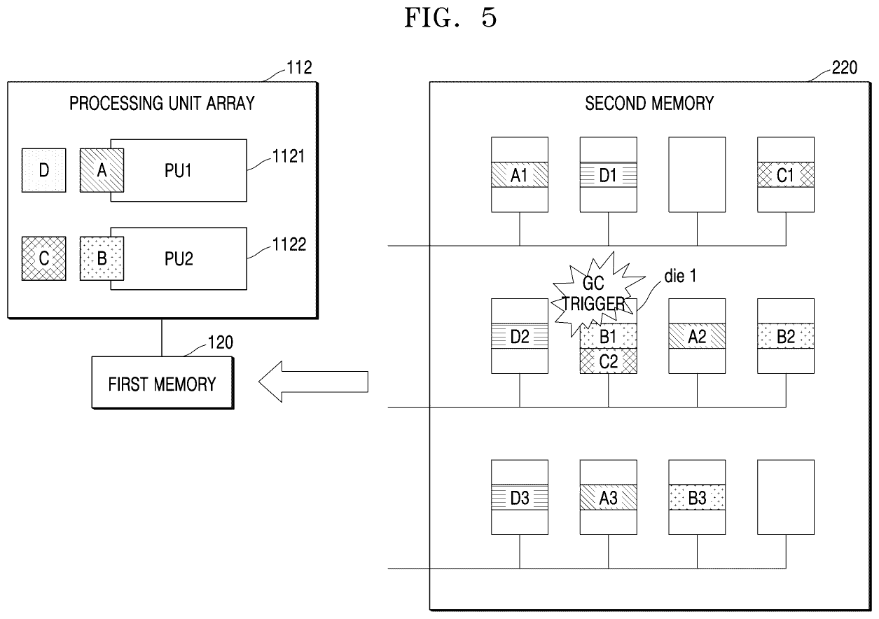

FIG. 5 is a diagram illustrating a case where long latency occurs in data-set access, according to some embodiments.

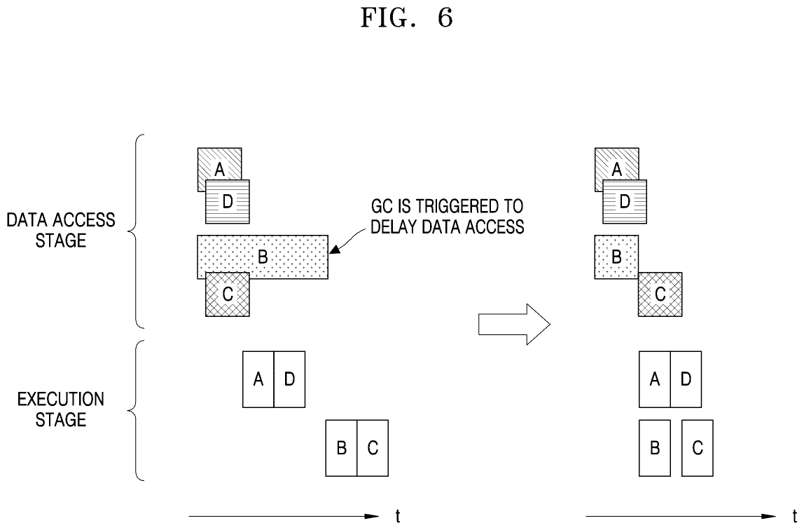

FIGS. 6 to 9 are diagrams illustrating an operation of generating data-set access order information with reduced long latency based on long-latency analysis information, according to some embodiments.

Referring to FIG. 5, the processing unit array 112 may include a first processing unit 1121 and a second processing unit 1122. A processing unit may calculate a data-set allocated to the processing unit, wherein a data-set to be allocated to the processing unit may be preloaded into the first memory 120. For example, data-set A may be allocated to the first processing unit 1121 as a target of a workload and data-set D may be preloaded to the first memory 120. Data-set B may be allocated to the second processing unit 1122 as a target of a workload and data-set C may be preloaded to the first memory 120.

To this end, the latency may be analyzed when accessing data-set A, data-set B, data-set C, and data-set D simultaneously. In other words, the latency may be analyzed when accessing data-subset A1 to data-subset A3 constituting data-set A, data-subset B1 to data-subset B3 constituting data-set B, data-subset C1 to data-subset C3 constituting data-set C, and data-subset D1 to data-subset D3 constituting data-set D. The data-set state analyzer 115 of FIG. 1 may generate the analysis result that, in analyzing accesses to data-subset B1 and data-subset C2 stored in a first die (die 1) of the second memory 220, the long latency occurs in the access to data-subset B1 as the garbage collection is triggered in the first die (die 1) due to the access to data-subset C2.

Although FIG. 5 illustrates a case where the long latency occurs as the garbage collection is triggered, this is an example for description. The inventive concept is not limited thereto. The long latency may also occur when there are multiple pending write requests to a channel (e.g., CH1 to CHm in FIG. 2) or a way (e.g., W11 to W1n, W21 to W2n, Wm1 to Wmn in FIG. 2) where a data-set is accessed or when there are multiple pending requests due to the access to another data-set Referring to FIGS. 5 and 6, when accessing data-set B and data-set C simultaneously, the data-set access scheduler 114 of FIG. 1 receiving the analysis result from the data-set state analyzer 115 of FIG. 1 may select a policy that changes the access order such that the access to data-set B is prior to the access to data-set C, to prevent the long latency in the access to data-set B, resulting in delayed computation of data-set B and data-set C.

For example, the garbage collection may be triggered in the first die (die 1) of the second memory 220 due to the access to data-set C (in particular, access to data-subset C2). As a result, when the long latency occurs in the access to data-set B, the data-set access scheduler 114 in FIG. 1 may change the access order such that the access to data-set C is subsequent to the access to data-set B. Thus, the access to data-subset C2 may be performed after the access to data-set B1 is completed, thereby preventing the long latency in the access to data-subset B1 due to the access to data-subset C2. As a result, a delay in computation of data-set B may be prevented and a delay in computation of data-set C may be minimized.

Although not shown, in another example, the data-set access scheduler 114 of FIG. 1 may change the access order such that the access to data-subset C2 is subsequent to the access to data-subset B1, thereby preventing the long latency in the access to data-subset B1 due to the access to data-subset C2. A period of accessing data-subset B2 and/or a period of accessing data-subset B3 may partially overlap with a period of accessing data-set C.

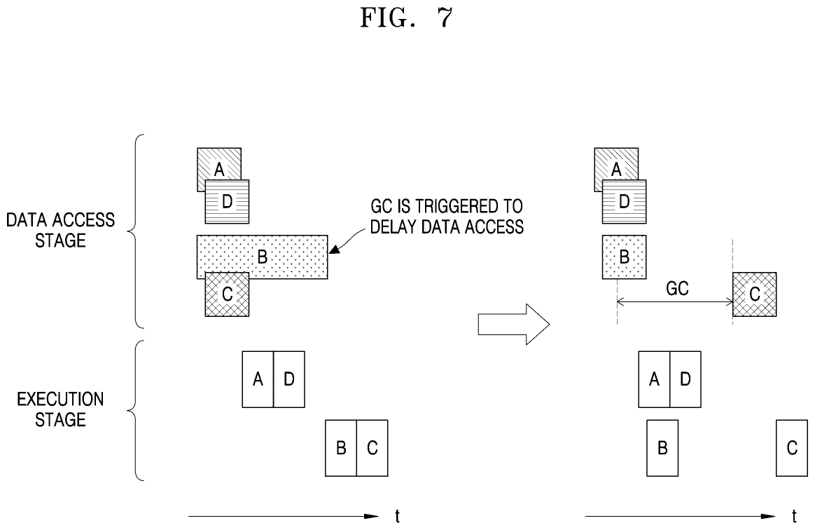

Referring to FIGS. 5 and 7, the data-set access scheduler 114 of FIG. 1 receiving the analysis result from the data-set state analyzer 115 of FIG. 1 may select a policy that induces early activation of garbage collection.

That is, the data-set access scheduler 114 of FIG. 1 may select a policy that changes the access order such that the access data-set B is prior to the access data-set C, and induces early activation of garbage collection, i.e., garbage collection GC to be activated before accessing data-set C. Accordingly, when data-subset B1 is accessed first, the garbage collection GC is activated early, and the garbage collection GC is completed, the data-subset C2 may be accessed. This is a solution to reduce the time delay due to the garbage collection GC, which consequently prevents the delay of computation of data-set B and minimizes the delay of computation of data-set C when the garbage collection GC is activated.

By accessing data-set B assigned to the processing unit and then accessing data-set C to be assigned to the processing unit after the garbage collection GC, the delay in accessing data-set B and computing data-set B assigned to the processing unit may be prevented.

However, unlike shown in FIG. 7, a policy that changes the access order such that access to another data-set (e.g., data-set C) that causes long latency (e.g., triggers garbage collection) is prior to the access to a target data-set (e.g., data-set B) may be possible.

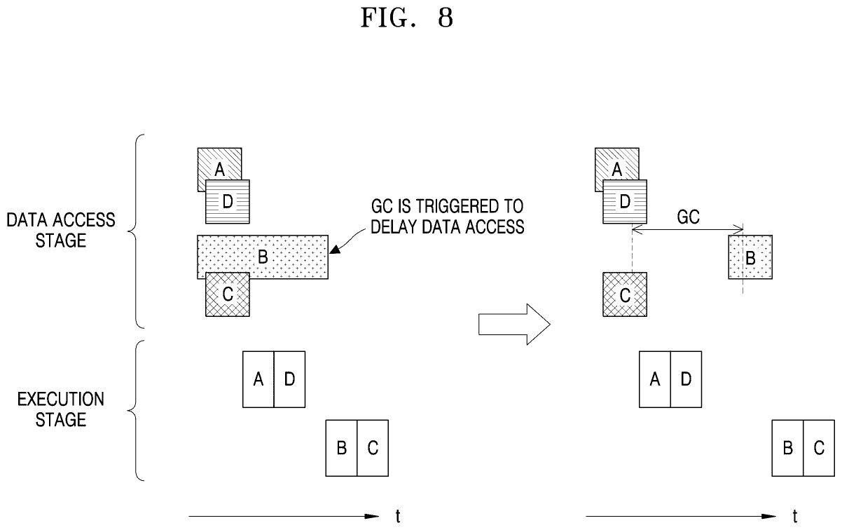

Referring to FIGS. 5 and 8, the data-set access scheduler 114 of FIG. 1 receiving the analysis result from the data-set state analyzer 115 of FIG. 1 may select a policy that changes the access order such that the access to the target data-set that causes long latency is prior to the access to another data-set access and a policy that induces early activation of garbage collection.

That is, the data-set access scheduler 114 of FIG. 1 may select a policy that changes the access order such that the access to data-set C is prior to the access to data-set B and induces early activation of garbage collection. Accordingly, when the data-subset C2 is accessed first, the garbage collection GC may be activated early. When the garbage collection GC is completed, the data-subset B1 may be accessed. This is a solution to reduce the time delay due to the garbage collection GC. As a result, this may reduce the delay of computation of the data-set B and the data-set C when the garbage collection GC is activated.

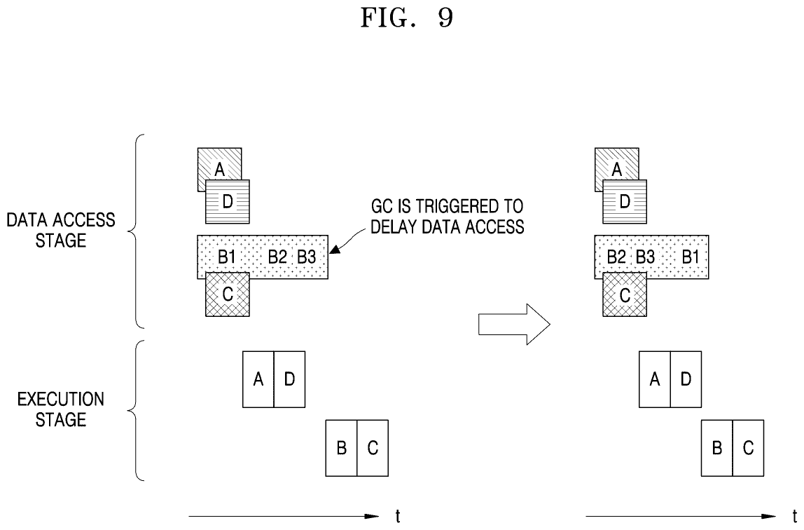

Referring to FIGS. 5 and 9, the data-set access scheduler 114 of FIG. 1 may select a policy that changes the access order of data-subsets constituting a data-set where long latency may occur.

That is, the data-set access scheduler 114 of FIG. 1 may change the access order such that the access to the data-subset where the long latency does not occur is prior to the access to the data-subset where long latency occurs. For example, when the access to data-set B is in the order of data-subset B1, data-subset B2 and data-subset B3 before receiving the analysis result from the data-set state analyzer 115 of FIG. 1, the data-set access scheduler 114 of FIG. 1 receiving the analysis result from the data-set state analyzer 115 of FIG. 1 may select a policy that changes the access to data-set B into the order of data-subset B2, data-subset B3, and data-subset B1. Accordingly, when data-subset C2, data-subset B2, and the data-subset B3 are accessed first, the garbage collection GC may be activated. When the garbage collection GC is completed, the data-subset B1 may be accessed. This is a solution to reduce the time delay due to the access to data-set B. As a result, this may reduce the delay of computation of data-set B and data-set C when the garbage collection GC is activated.

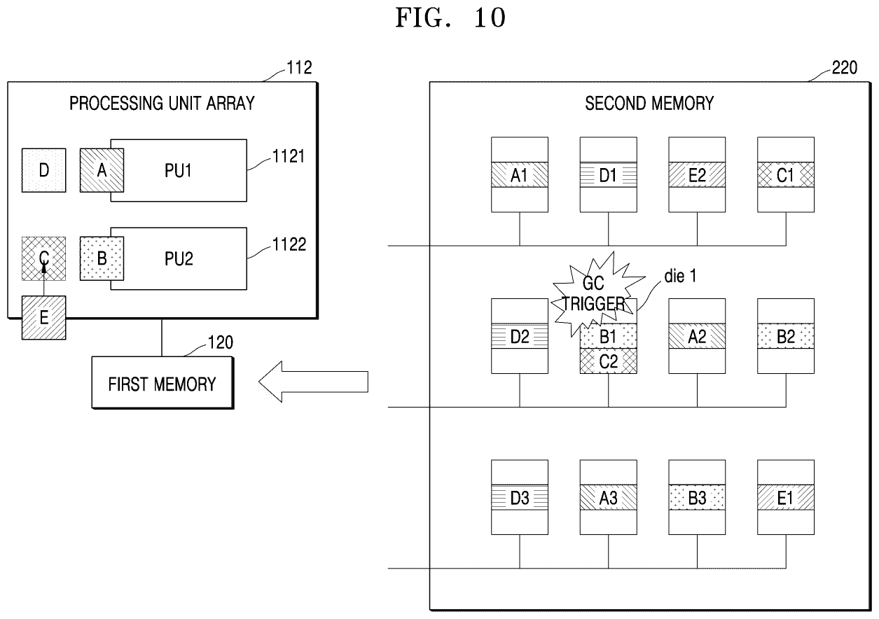

FIG. 10 is a diagram illustrating a case where long latency occurs in data-set access, according to some embodiments.

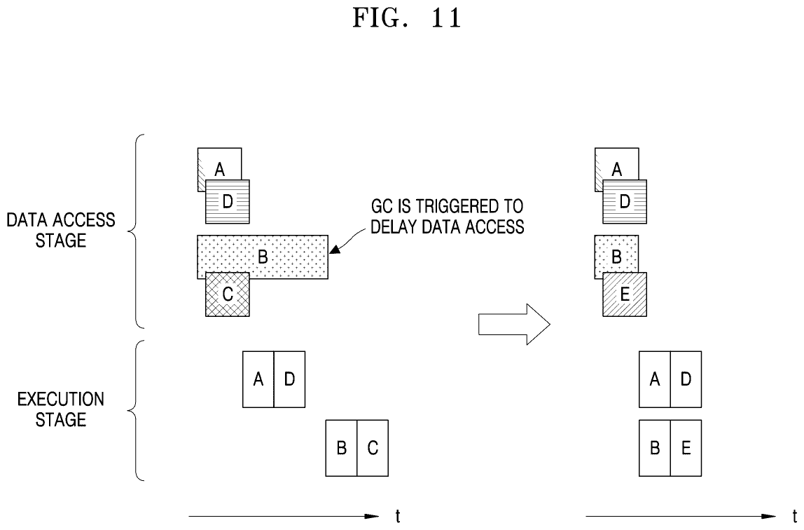

FIG. 11 is a diagram illustrating an operation of generating data-set access order information with reduced long latency based on long-latency analysis information, according to some embodiments.

Referring to FIG. 10, the processing unit array 112 may include a first processing unit 1121 and a second processing unit 1122. The processing unit may calculate a data-set allocated to the processing unit, wherein a data-set to be allocated to the processing unit may be preloaded into the first memory 120. For example, data-set A may be allocated to the first processing unit 1121 as a target of a workload and data-set D may be preloaded to the first memory 120. The data-set B may be allocated to the second processing unit 1122 as a target of a workload, and the data-set C may be preloaded to the first memory 120.

To this end, the latency may be analyzed when the data-set A, data-set B, data-set C, and data-set D are accessed simultaneously. In other words, the latency may be analyzed when data-subset Al to data-subset A3 constituting data-set A, data-subset B1 to data-subset B3 constituting data-set B, data-subset C1 to data-subset C3 constituting data-set C, and data-subset D1 to data-subset D3 constituting data-set D are accessed simultaneously. The data-set state analyzer 115 of FIG. 1 may generate the analysis result that, in analyzing accesses to data-subset B1 and data-subset C2 stored in the first die (die 1) of the second memory 220, the long latency occurs in the access to data-subset B1 as the garbage collection is triggered in the first die (die 1) due to the access to data-subset C2.

Referring to FIGS. 10 and 11, the data-set access scheduler 114 of FIG. 1 receiving the analysis result from the data-set state analyzer 115 of FIG. 1 may select a policy that changes the order of accessing a new data-set where long latency does not occur to the order of accessing the target data-set, to prevent delayed computation of data-set B and data-set C due to long latency in the access to data-set B. That is, the data-set access scheduler 114 of FIG. 1 may select a policy that changes the order of accessing data-set E to the order of accessing data-set C. Accordingly, the data-set B may be allocated to the second processing unit 1122 as a target of a workload, the data-set E may be preloaded to the first memory 120, and the data-set B and data-set E may be accessed together. As a result, the delayed computation of data-set B may be prevented.

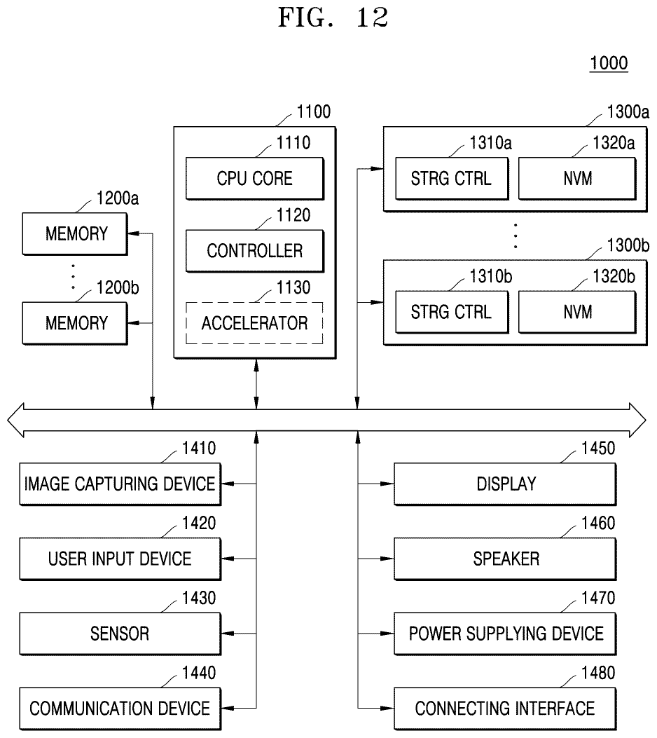

FIG. 12 is a diagram of a system 1000 to which a data access apparatus, according to some embodiments, is applied.

The system 1000 of FIG. 12 may basically include a mobile system, such as a mobile phone, a smartphone, a tablet personal computer (PC), a wearable device, a healthcare device, or an internet of things (IOT) device. However, the system 1000 of FIG. 1 is not necessarily limited to

the mobile system. The system 1000 of FIG. 1 may include a personal computer, a laptop computer, a server, a media player, an automotive device, such as navigation, or the like.

Referring to FIG. 12, the system 1000 may include a main processor 1100, memories 1200a and 1200b, and storage devices 1300a and 1300b, and may further include one or more of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and more specifically, the operation of the other components constituting the system 1000. The main processor 1100 may be implemented as a general-purpose processor, a dedicated processor, an application processor, or the like.

The main processor 1100 may include one or more CPU cores 1110 and may further include a controller 1120 for controlling the memories 1200a and 1200b and/or the storage devices 1300a and 1300b. According to some embodiments, the main processor 1100 may further include an accelerator 1130, which is a dedicated circuit for high-speed data computation, such as artificial intelligence (AI) data computation. The accelerator 1130 may include a GPU, an NPU, and/or a DPU, and may be implemented as a separate chip physically independent of the other components of the main processor 1100. In some embodiments, the accelerator 1130 may include a data access apparatus including the data-set access scheduler 114, the data-set state analyzer 115, and the data-set manager 116 in FIG. 1. The accelerator 1130 may generate data-set access order information that minimizes the long latency in data-set access and consequently minimizes the delay of computation. Therefore, it is possible to minimize a computation error by quickly processing the large-scale computation, such as LLM.

The memories 1200a and 1200b may be used as the main memory of the system 1000. The memories 1200a and 1200b may include volatile memory, such as SRAM and/or DRAM but may also include NVM, such as flash memory, PRAM, and/or RRAM.

The storage devices 1300a and 1300b may function as a non-volatile storage device that stores data regardless of whether power is supplied and may have a relatively large storage capacity, compared to the memories 1200a and 1200b. The storage devices 1300a and 1300b may include

storage controllers 1310a and 1310b and NVMs 1320a and 1320b that store data under the control by the storage controllers 1310a and 1310b, respectively. The NVMs 1320a and 1320b may include flash memory having a 2D structure or a 3D (or vertical) NAND (VNAND) structure. However, the NVMs 1320a and 1320b may also include other types of non-volatile memory, such as PRAM and/or RRAM.

The storage devices 1300a and 1300b may be included in the system 1000, physically separate from the main processor 1100 and may be implemented in the same package as the main processor 1100. In addition, the storage devices 1300a and 1300b having a form of, e.g., a solid-state device (SSD) or a memory card, may be detachably coupled to the other components of the system 1000 through an interface, such as the connecting interface 1480 to be described below. The storage devices 1300a and 1300b may include devices to which a standard protocol, such as universal flash storage (UFS), embedded multi-media card (eMMC), or NVM express (NVMe), is applied, but are not necessarily limited thereto.

The image capturing device 1410 may capture a still image or a video, and may include a camera, a camcorder, and/or a webcam.

The user input device 1420 may receive various types of data input from a user of the system 1000 and may include a touch pad, a keypad, a keyboard, a mouse, and/or a microphone.

The sensor 1430 may sense various types of physical quantities obtained from the outside of the system 1000 and convert the sensed physical quantities into electrical signals. The sensor 1430 may include a temperature sensor, a pressure sensor, an illuminance sensor, a position sensor, an acceleration sensor, a biosensor, and/or a gyroscope sensor.

The communication device 1440 may exchange signals with other devices outside the system 1000 according to various communication protocols. The communication device 1440 may include an antenna, a transceiver, and/or a modem.

The display 1450 and the speaker 1460 may function as output devices that output visual information and auditory information, respectively, to the user of the system 1000.

The power supplying device 1470 may appropriately convert power supplied from a battery (not shown) built in the system 1000 and/or an external power source and may supply the same to each component of the system 1000.

The connecting interface 1480 may provide connection between the system 1000 and an external device, which is connected to the system 1000 and is capable of transmitting and receiving data to and from the system 1000. The connecting interface 1480 may be implemented in various interface manners, such as advanced technology attachment (ATA), serial ATA (SATA), external SATA (e-SATA), small computer small interface (SCSI), serial attached SCSI (SAS), peripheral component interconnect (PCI), PCI express (PCIe), NVMe, IEEE 1394, universal serial bus (USB), secure digital (SD) card, multi-media card (MMC), eMMC, UFS, embedded UFS (eUFS), compact flash (CF) card interface, and the like.

While the inventive concept has been particularly shown and described with reference to embodiments thereof, it will be understood that various changes in form and details may be made therein without departing from the spirit and scope of the following claims.

What is claimed is:

1. A data access apparatus, comprising:
a data-set access scheduler configured to generate data-set access order information based on information on a plurality of data-set addresses for a plurality of data-sets and long-latency analysis information;
a data-set manager configured to access the plurality of data-sets in heterogeneous memories including a first memory and a second memory based on the data-set access order information; and
a data-set state analyzer configured to generate the long-latency analysis information based on the information on the plurality of data-set addresses and state information for the second memory.

2. The data access apparatus of claim 1, wherein the information on the plurality of data-set addresses comprises information indicating locations where a plurality of data-subsets that are part of each of the plurality of data-sets are stored in the second memory.

3. The data access apparatus of claim 1, wherein the long-latency analysis information comprises information indicating whether long latency occurs in access to one or more data-sets due to at least one of a plurality of states in which more than a predetermined number of access requests are pending, garbage collection is activated, and defensive code is activated.

4. The data access apparatus of claim 1, wherein the data-set access scheduler determines a long-latency occurrence type based on the long-latency analysis information, selects a first scheduling policy corresponding to a first long-latency occurrence type, selects a second scheduling policy corresponding to a second long-latency occurrence type, and generates the set access order information according to the first scheduling policy or the second scheduling policy, and
the first long-latency occurrence type comprises a type in which long latency occurs in access to a target data-set due to the access to the target data-set and the second long-latency occurrence type comprises a type in which long latency occurs in access to another data-set due to the access to the target data-set.

5. The data access apparatus of claim 4, wherein the first scheduling policy comprises at least one of a policy that changes the access to the target data-set to a highest priority, a policy that induces early activation of garbage collection, and a policy that induces early activation of defensive code.

6. The data access apparatus of claim 4, wherein the second scheduling policy comprises at least one of a policy that changes an access order such that the access to the another data-set is prior to the access to the target data-set, a policy that changes the access order such that the access to the target data-set is prior to the access to the another data-set, a policy that induces early activation of garbage collection, and a policy that induces early activation of defensive code.

7. The data access apparatus of claim 4, wherein the first scheduling policy and the second scheduling policy each comprise a policy that changes an order of accessing a new data-set in which long latency does not occur to an order of accessing the target data-set.

8. The data access apparatus of claim 1, wherein the first memory comprises a buffer memory and the second memory comprises a non-volatile memory.

9. The data access apparatus of claim 8, wherein the first memory and the second memory each store at least one of a data-set required for computation and an intermediate data-set generated during the computation.

10. A data access apparatus, comprising:
a first memory configured to store at least one of a data-set required for computation of a plurality of data-sets and an intermediate data-set generated during the computation;
a second memory configured to store the plurality of data-sets;
a data-set access scheduler configured to receive information on a plurality of data-set addresses, generate a request for analysis of long latency in access to one or more data-sets, and generate data-set access order information with reduced long latency based on long-latency analysis information corresponding to the request for analysis of long latency;
a data-set state analyzer configured to receive the information on the plurality of data-set addresses, receive the request for analysis of long latency from the data-set access scheduler, receive state information for the second memory, generate the long-latency analysis information for access to the one or more data-sets based on the information on the plurality of data-set addresses, the request for analysis of long latency, and the state information for the second memory, and transmit the long-latency analysis information to the data-set access scheduler;
a workload scheduler configured to receive the data-set access order information from the data-set access scheduler and generate data-set computation order information for the plurality of data-sets based on the data-set access order information; and
a data-set manager configured to receive the data-set access order information from the data-set-access scheduler, and access the data-sets in heterogeneous memories including the first memory and the second memory based on the data-set access order information wherein the first memory comprises a buffer memory and the second memory comprises a non-volatile memory.

11. The data access apparatus of claim 10, wherein the long-latency analysis information comprises information indicating whether long latency occurs in access to the one or more data-sets due to at least one of states in which more than a predetermined number of access requests are pending, garbage collection is activated, and defensive code is activated.

12. The data access apparatus of claim 10, wherein the data-set access scheduler determines a long-latency occurrence type based on the long-latency analysis information, selects a first scheduling policy corresponding to a first long-latency occurrence type, selects a second scheduling policy corresponding to a second long-latency occurrence type, and generates the data-set access order information according to the first scheduling policy or the second scheduling policy, and
the first long-latency occurrence type comprises a type in which long latency occurs in access to a target data-set due to the access to the target data-set and the second long-latency occurrence type comprises a type in which long latency occurs in access to another data-set due to the access to the target data-set.

13. The data access apparatus of claim 12, wherein the first scheduling policy comprises at least one of a policy that changes the access to the target data-set to a highest priority, a policy that induces early activation of garbage collection, and a policy that induces early activation of defensive code.

14. The data access apparatus of claim 12, wherein the second scheduling policy comprises at least one of a policy that changes an access order such that the access to the another data-set is prior to the access to the target data-set, a policy that changes the access order such that the access to the target data-set is prior to the access to the another data-set, a policy that induces early activation of garbage collection, and a policy that induces early activation of defensive code.

15. The data access apparatus of claim 12, wherein the first scheduling policy and the second scheduling policy each comprise a policy that changes an order of accessing a new data-set in which long latency does not occur to an order of accessing the target data-set.

16. An operating method of a data access apparatus comprising heterogeneous memories including a first memory and a second memory and performing computation operations on each of a plurality of data-sets, the operating method comprising:
analyzing whether long latency occurs in access to the plurality of data-sets based on information on a plurality of data-set addresses for the plurality of data-sets, a request for analysis of long latency, and state information for the second memory, and generating long-latency analysis information;
generating data-set access order information for the plurality of data-sets based on the long-latency analysis information; and
accessing the first memory and the second memory based on the data-set access order information wherein the first memory comprises a buffer memory and the second memory comprises a non-volatile memory.

17. The operating method of claim 16, wherein the long-latency analysis information comprises information indicating whether long latency occurs in access to one or more data-sets due to at least one of a plurality of states in which more than a predetermined number of access requests are pending, garbage collection is activated, and defensive code is activated.

18. The operating method of claim 16, wherein the generating of the data-set access order information comprises:
distinguishing, based on the long-latency analysis information, a type in which long latency occurs in access to a target data-set due to the access to the target data-set as a first long-latency occurrence type, selecting a first scheduling policy corresponding to the first long-latency occurrence type, and generating the data-set access order information according to the first scheduling policy; and
distinguishing, based on the long-latency analysis information, a type in which long latency occurs in access to another data-set due to the access to the target data-set as a second long-latency occurrence type, selecting a second scheduling policy corresponding to the second latency occurrence type, and generating the data-set access order information according to the second scheduling policy.

19. The operating method of claim 18, wherein the first scheduling policy comprises at least one of a policy that changes the access to the target data-set to a highest priority, a policy that induces early activation of garbage collection, and a policy that induces early activation of defensive code.

20. The operating method of claim 18, wherein the second scheduling policy comprises at least one of a policy that changes an access order such that the access to the another data-set is prior to the access to the target data-set, a policy that changes the access order such that the access to the target data-set is prior to the access to the another data-set, a policy that induces early activation of garbage collection, and a policy that induces early activation of defensive code.
